(19) United States
(12) Patent Application Publication
(10) Pub. No.: US 2025/0304102 A1
(43) Pub. Date: Oct. 2, 2025

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Daichi Inoue, Tokyo (JP)

(21) Appl. No.: 19/049,176

(22) Filed: Feb. 10, 2025

(30) Foreign Application Priority Data
Mar. 29, 2024 (JP) 2024-056047

(51) Int. Cl. B60W 60/00; G01C 21/00

(52) U.S. Cl. CPC B60W 60/001; G01C 21/3822; B60W 2552/10; B60W 2552/30; B60W 2552/53; B60W 2554/4041; B60W 2556/40

(57) ABSTRACT

Disclosed is a vehicle control device including: a storage medium storing computer-readable instructions; and a processor connected to the storage medium, the processor executing the computer-readable instructions, wherein, in a case in which it is determined that there is a deviation between the recognized road dividing line and the map road dividing line, when the other vehicle is recognized, the processor performs the traveling control on the basis of the road dividing line that is closer to a movement trajectory of the other vehicle between the recognized road dividing line and the map road dividing line, whereas when no other vehicle is recognized, the processor performs the traveling control on the basis of the road dividing lines with a smaller change in the lane width between the recognized road dividing lines and the map road dividing lines.

### CROSS-REFERENCE TO RELATED APPLICATION

Priority is claimed on Japanese Patent Application No. 2024-056047, filed on Mar. 29, 2024, the contents of which are incorporated herein by reference.

### BACKGROUND

### Field of the Invention

The present invention relates to a vehicle control device, a vehicle control method, and a storage medium.

### Description of Related Art

In recent years, efforts to provide access to sustainable transportation systems that consider vulnerable people among transportation participants have intensified. In order to achieve this, research and development is focusing on further improving the safety and convenience of traffic through the research and development of automatic driving technologies.

Incidentally, in automatic driving technologies, a road dividing line recognized from a camera image (hereinafter sometimes referred to as a camera road dividing line) is confirmed to match a road dividing line recognized from map information (hereinafter sometimes referred to as a map road dividing line), and traveling control of an own vehicle is performed on the basis of the matching camera road dividing line and map road dividing line on both sides or one side. At this time, it is estimated which of the camera road dividing line or the map road dividing line is more reliable. For example, Japanese Unexamined Patent Application, First Publication No. 2017-146724 describes a technology that compares a map road dividing line with a traveling trajectory of a preceding vehicle, and in a case in which the two are not similar, determines that the reliability of the map road dividing line is low.

In this way, in the related art, the reliability of the map road dividing line is determined by comparing it with the traveling trajectory of the preceding vehicle, but it is not possible to continue the traveling control of the vehicle with a high degree of accuracy by combining a plurality of traveling road determinations with each other.

### SUMMARY

The present invention has been made in consideration of such circumstances, and an object of the present invention is to provide a vehicle control device, vehicle control method, and a storage medium in which it is possible to continue traveling control of a vehicle with a high degree of accuracy by combining a plurality of traveling road determinations. Furthermore, the object of the present invention is to contribute to the development of sustainable transportation systems.

A vehicle control device according to the present invention employs the following configuration.

(1) According to an aspect of the present invention, there is provided a vehicle control device including: a storage medium storing computer-readable instructions; and a processor connected to the storage medium, the processor executing the computer-readable instructions to: recognize a road dividing line and the other vehicle present in a traveling direction of a vehicle; determine whether or not the recognized road dividing line matches a map road dividing line based on map information stored in a storage unit, and determine a deviation between the recognized road dividing line and the map road dividing line that match each other; calculate a distance between road dividing lines on both sides of each of the recognized road dividing line and the map road dividing line as a lane width; and perform traveling control of the vehicle on the basis of at least one of the recognized road dividing line and the map road dividing line, wherein, in a case in which it is determined that there is a deviation between the recognized road dividing line and the map road dividing line, when the other vehicle is recognized, the processor performs the traveling control on the basis of the road dividing line that is closer to a movement trajectory of the other vehicle between the recognized road dividing line and the map road dividing line, whereas when no other vehicle is recognized, the processor performs the traveling control on the basis of the road dividing lines with a smaller change in the lane width between the recognized road dividing lines and the map road dividing lines.

(2) In the above aspect (1), in a case in which the change in the lane width of the recognized road dividing lines is greater than or equal to a threshold value, the processor performs the traveling control on the basis of the map road dividing line, whereas in a case in which the change in the lane width of the map road dividing lines is greater than or equal to the threshold value, the processor performs the traveling control on the basis of the recognized road dividing line.

(3) In the above aspect (1), in a case in which it is determined that both the recognized road dividing line and the map road dividing line are along the movement trajectory of the other vehicle, the processor performs the traveling control on the basis of the road dividing line that is closer to the movement trajectory of the other vehicle between the recognized road dividing line and the map road dividing line.

(4) In the above aspect (1), in a case in which it is determined that the recognized road dividing line and the map road dividing line match each other on only one side and that a deviation has occurred on the one side, when the other vehicle is recognized, the processor performs the traveling control on the basis of the road dividing line that is closer to the movement trajectory of the other vehicle between the recognized road dividing line and the map road dividing line, whereas when no other vehicle is recognized, the processor performs the traveling control on the basis of the road dividing lines with a smaller change in the lane width between the recognized road dividing lines and the map road dividing lines.

(5) In the above aspect (1), in a case in which the vehicle is not changing lanes and it is determined that there is a deviation between the recognized road dividing line and the map road dividing line, when the other vehicle is recognized, the processor performs the traveling control on the basis of the road dividing line that is closer to the movement trajectory of the other vehicle between the recognized road dividing line and the map road dividing line, whereas when no other vehicle is recognized, the processor performs the traveling control on the basis of the road dividing lines with a smaller change in the lane width between the recognized road dividing lines and the map road dividing lines.

(6) In the above aspect (1), in a case in which an index value indicating a degree of curvature of a traveling lane of the vehicle is less than or equal to a predetermined value and it is determined that there is a deviation between the recognized road dividing line and the map road dividing line, when the other vehicle is recognized, the processor performs the traveling control on the basis of the road dividing line that is closer to the movement trajectory of the other vehicle between the recognized road dividing line and the map road dividing line, whereas when no other vehicle is recognized, the processor performs the traveling control on the basis of the road dividing lines with a smaller change in the lane width between the recognized road dividing lines and the map road dividing lines.

(7) In the above aspect (1), in a case in which the vehicle is not traveling near a branch road and it is determined that there is a deviation between the recognized road dividing line and the map road dividing line, when the other vehicle is recognized, the processor performs the traveling control on the basis of the road dividing line that is closer to the movement trajectory of the other vehicle between the recognized road dividing line and the map road dividing line, whereas when no other vehicle is recognized, the processor performs the traveling control on the basis of the road dividing lines with a smaller change in the lane width between the recognized road dividing lines and the map road dividing lines.

(8) According to another aspect of the present invention, there is provided a vehicle control method causing a computer installed in a vehicle to: recognize a road dividing line and the other vehicle present in a traveling direction of a vehicle; determine whether or not the recognized road dividing line matches a map road dividing line based on map information stored in a storage unit, and determine a deviation between the recognized road dividing line and the map road dividing line that match each other; calculate a distance between road dividing lines on both sides of each of the recognized road dividing line and the map road dividing line as a lane width; and perform traveling control of the vehicle on the basis of at least one of the recognized road dividing line and the map road dividing line, wherein, in a case in which it is determined that there is a deviation between the recognized road dividing line and the map road dividing line, when the other vehicle is recognized, the traveling control is performed on the basis of the road dividing line that is closer to a movement trajectory of the other vehicle between the recognized road dividing line and the map road dividing line, whereas when no other vehicle is recognized, the traveling control is performed on the basis of the road dividing lines with a smaller change in the lane width between the recognized road dividing lines and the map road dividing lines.

(9) According to still another aspect of the present invention, there is provided a computer-readable non-transitory storage medium that stores a program causing a computer installed in a vehicle to: recognize a road dividing line and the other vehicle present in a traveling direction of a vehicle; determine whether or not the recognized road dividing line matches a map road dividing line based on map information stored in a storage unit, and determine a deviation between the recognized road dividing line and the map road dividing line that match each other; calculate a distance between road dividing lines on both sides of each of the recognized road dividing line and the map road dividing line as a lane width; and perform traveling control of the vehicle on the basis of at least one of the recognized road dividing line and the map road dividing line, wherein, in a case in which it is determined that there is a deviation between the recognized road dividing line and the map road dividing line, when the other vehicle is recognized, the traveling control is performed on the basis of the road dividing line that is closer to a movement trajectory of the other vehicle between the recognized road dividing line and the map road dividing line, whereas when no other vehicle is recognized, the traveling control is performed on the basis of the road dividing lines with a smaller change in the lane width between the recognized road dividing lines and the map road dividing lines.

According to the above aspects (1) to (9), it is possible to continue the traveling control of the vehicle with a high degree of accuracy by combining a plurality of traveling road determinations with each other.

According to the above aspect (1), in a case in which there is no preceding vehicle ahead of the own vehicle, the road dividing lines with a smaller change in the lane width between the recognized road dividing lines and the map road dividing lines are selected to continue the traveling control, and in a case in which there is no preceding vehicle ahead of the own vehicle, the road dividing line that is closer to the preceding vehicle is selected to continue the traveling control, and thus it is possible to continue the traveling control with greater accuracy than in a case in which the determination is based only on the lane width.

According to the above aspect (2), in a case in which there is an extremely large change in the lane width between the recognized road dividing lines and the map road dividing lines, it is determined to be a false detection, and it is possible to continue the traveling control on the basis of the road dividing lines with a smaller change in the lane width, regardless of the presence of the preceding vehicle.

According to the above aspect (3), even in a case in which both the recognized road dividing line and the map road dividing line are along the movement trajectory of the preceding vehicle, it is possible to continue the traveling control on the basis of the road dividing lines with a smaller change in the lane width.

According to the above aspect (4), in a case in which the recognized road dividing line and the map road dividing line match each other on only one side, it is possible to continue the traveling control on the basis of either of the recognized road dividing line or the map road dividing line.

According to the above aspects (5) to (7), it is possible to suppress erroneous determinations due to the present determination processing.

### BRIEF DESCRIPTION OF THE DRAWINGS

FIG. 1 is a configuration diagram of a vehicle system using a vehicle control device according to an embodiment.

FIG. 2 is a functional configuration diagram of a first control unit and a second control unit.

FIG. 3 is a diagram showing an example of a correspondence relationship between a driving mode, a control state of an own vehicle, and a task.

FIG. 4 is a diagram for explaining erroneous selection of a traveling road in the related art.

FIG. 5 is a diagram for explaining an overview of basic processing, the present invention processing 1, and the present invention processing 2 according to the embodiment.

FIG. 6 is a diagram for explaining details of the basic processing according to the embodiment.

FIG. 7 is a diagram for explaining details of the present invention processing 1 according to the embodiment.

FIG. 8 is a graph for explaining a method for determining a road dividing line to be output in the present invention processing 1.

FIG. 9 is a flowchart showing an example of the flow of the present invention processing 2 according to the embodiment.

### DESCRIPTION OF EMBODIMENTS

Hereinafter, embodiments of a vehicle control device, a vehicle control method, and a storage medium of the present invention will be described with reference to the drawings.

### [Overall Configuration]

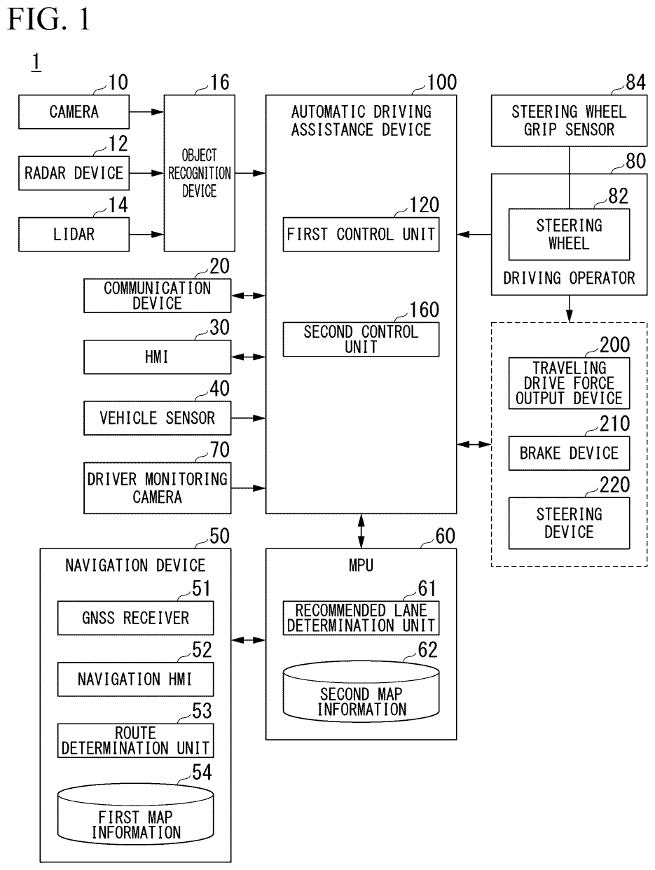

FIG. 1 is a configuration diagram of a vehicle system 1 using a vehicle control device according to an embodiment. The vehicle in which the vehicle system 1 is equipped is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using the electric power generated by a generator connected to an internal combustion engine or the electric power discharged from a secondary battery or a fuel cell.

The vehicle system 1 is equipped with, for example, a camera 10, a radar device 12, a light detection and ranging (LIDAR) 14, an object recognition device 16, a communication device 20, a human machine interface (HMI) 30, and a vehicle sensor 40, a navigation device 50, a map positioning unit (MPU) 60, a driver monitoring camera 70, an driving operator 80, an automatic driving control device 100, a traveling drive force output device 200, a brake device 210, and a steering device 220. These devices and instruments are connected to each other by a multiplex communication line such as a controller area network (CAN) communication line, a serial communication line, a wireless communication network, or the like. A configuration shown in FIG. 1 is merely an example, and some of the configuration may be omitted or another configuration may be added.

The camera 10 is, for example, a digital camera that uses a solid-state imaging sensor such as a charge coupled device (CCD) or a complementary metal oxide semiconductor (CMOS). The camera 10 is attached to an arbitrary location on the vehicle on which the vehicle system 1 is installed (hereinafter referred to as an own vehicle M). In a case in which the forward portion is imaged, the camera 10 is attached to an upper portion of a front windshield, a back surface of a rearview mirror, and the like. The camera 10 periodically and repeatedly images the surroundings of the own vehicle M, for example. The camera 10 may be a stereo camera.

The radar device 12 radiates radio waves such as millimeter waves near the own vehicle M and detects the radio waves (reflected waves) reflected by an object to detect at least the position (the distance and direction) of the object. The radar device 12 is attached to an arbitrary location on the own vehicle M. The radar device 12 may detect the position and the speed of the object by a frequency modulated continuous wave (FM-CW) method.

The LIDAR 14 irradiates the surroundings of the own vehicle M with light (or electromagnetic waves having a wavelength close to that of light) and measures the scattered light. The LIDAR 14 detects a distance to a target on the basis of a time from light emission to light reception. The emitted light is, for example, a pulsed laser beam. The LIDAR 14 is attached to an arbitrary location on the own vehicle M.

The object recognition device 16 performs sensor fusion processing on detection results obtained by some or all of the camera 10, the radar device 12, and the LIDAR 14 and recognizes the position, the type, the speed, and the like of the object. The object recognition device 16 outputs recognition results to the automatic driving control device 100. The object recognition device 16 may output the detection results of the camera 10, the radar device 12, and the LIDAR 14 to the automatic driving control device 100 as they are. The object recognition device 16 may be omitted from the vehicle system 1.

The communication device 20 communicates with another vehicle near the own vehicle M using, for example, a cellular network, a Wi-Fi network, Bluetooth (registered trademark), dedicated short range communication (DSRC), and the like or communicates with various server devices via a radio base station.

The HMI 30 presents various items of information to the occupant of the own vehicle M and also accepts input operations performed by the occupant. The HMI 30 includes various display devices, a speaker, a buzzer, a touch panel, a switch, a key, and the like.

The vehicle sensor 40 includes a vehicle speed sensor that detects the speed of the own vehicle M, an acceleration sensor that detects the acceleration, a yaw rate sensor that detects the angular speed around the vertical axis, a direction sensor that detects the direction of the own vehicle M, and the like.

The navigation device 50 includes, for example, a global navigation satellite system (GNSS) receiver 51, a navigation HMI 52, and a route determination unit 53. The navigation device 50 holds first map information 54 in a storage device such as a hard disk drive (HDD) or a flash memory. The GNSS receiver 51 identifies the position of the own vehicle M on the basis of a signal received from GNSS satellites. The position of the own vehicle M may be specified or complemented by an inertial navigation system (INS) using an output from the vehicle sensor 40. The navigation HMI 52 includes a display device, a speaker, a touch panel, a key, and the like. The navigation HMI 52 may be partially or wholly shared with the above-mentioned HMI 30. For example, the route determination unit 53 determines a route from a position of the own vehicle M specified by the GNSS receiver 51 (or an arbitrary input position) to a destination input by the occupant using the navigation HMI 52 (hereinafter referred to as a route on a map) with reference to the first map information 54. The first map information 54 is, for example, information in which a road shape is expressed with a link indicating a road and a node connected through the link. The first map information 54 may include road curvature, point of interest (POI) information, and the like. The route on the map is output to the MPU 60. The navigation device 50 may perform route guidance using the navigation HMI 52 on the basis of the route on the map. The navigation device 50 may be realized by, for example, the function of a terminal device such as a smartphone or a tablet terminal owned by the occupant. The navigation device 50 may transmit a current position and a destination to a navigation server via the communication device 20 and acquire a route equivalent to the route on the map from the navigation server.

The MPU 60 includes, for example, a recommended lane determination unit 61 and holds second map information 62 in a storage device such as an HDD or a flash memory. The recommended lane determination unit 61 divides the route on the map provided by the navigation device 50 into a plurality of blocks (for example, divides the route into 100 [m] units in a vehicle traveling direction) and determines a recommended lane for each block while referring to the second map information 62. The recommended lane determination unit 61 determines which lane from the left the vehicle travels in. In a case where a branch location is present on the route on the map, the recommended lane determination unit 61 determines the recommended lane such that the own vehicle M can travel on a reasonable route to proceed to a branch destination.

The second map information 62 is map information having higher accuracy than the first map information 54. The second map information 62 includes, for example, information on the center of the lane, information on the boundary of the lane, and the like. In addition, the second map information 62 may include road information, traffic regulation information, address information (an address and a postal code), facility information, telephone number information, information on a prohibited section where mode A or mode B, which will be described below, is prohibited, and the like. The second map information 62 may be updated at any time through the communication device 20 communicating with another device.

The driver monitoring camera 70 is a digital camera that uses, for example, a solid-state image sensor such as a CCD or CMOS. The driver monitoring camera 70 is attached at any location on the own vehicle M in a position and a direction that allow it to capture an image of the head of the occupant (hereinafter referred to as the driver) seated in the driver's seat of the own vehicle M from the front (in a direction in which an image of the face is captured). For example, the driver monitoring camera 70 is attached to the upper portion of a display device provided in the central portion of the instrument panel of the own vehicle M.

The driving operator 80 includes, for example, a steering wheel 82, an accelerator pedal, a brake pedal, a shift lever, and other operators. A sensor for detecting the amount of operation or the presence or absence of the operation is attached to the driving operator 80, and the detection results thereof are output to some or all of the automatic driving control device 100, the traveling drive force output device 200, the brake device 210, and the steering device 220. The steering wheel 82 is an example of an “operator that receives the steering operation by the driver.” The operator does not necessarily have to be annular and may be in a form of a modified steering wheel, a joystick, a button, or the like. A steering wheel grip sensor 84 is attached to the steering wheel 82. The steering wheel grip sensor 84 is realized by a capacitance sensor or the like and outputs a signal for detecting whether or not the driver is gripping the steering wheel 82 (a hand of the driver is in contact with the steering wheel 82 in a state where the driver applies a force to the steering wheel 82) to the automatic driving control device 100.

The automatic driving control device 100 includes, for example, a first control unit 120 and a second control unit 160. The first control unit 120 and the second control unit 160 are realized by, for example, a hardware processor such as a central processing unit (CPU) executing a program (software). In addition, some or all of these components may be realized by hardware (a circuit unit: including circuitry) such as a large scale integration (LSI), an application specific integrated circuit (ASIC), a field-programmable gate array (FPGA), a graphics processing unit (GPU), or a system on chip (SOC), or may be realized by software and hardware in cooperation. The program may be stored in advance in a storage device (a storage device including a non-transitory storage medium) such as an HDD or a flash memory of the automatic driving control device 100, or may be stored in an attachable and detachable storage medium such as a DVD or a CD-ROM. In the latter case, the storage medium (the non-transitory storage medium) may be loaded in a drive device, and thus the program may be installed in an HDD or a flash memory of the automatic driving control device 100. The automatic driving control device 100 is an example of a “vehicle control device.”

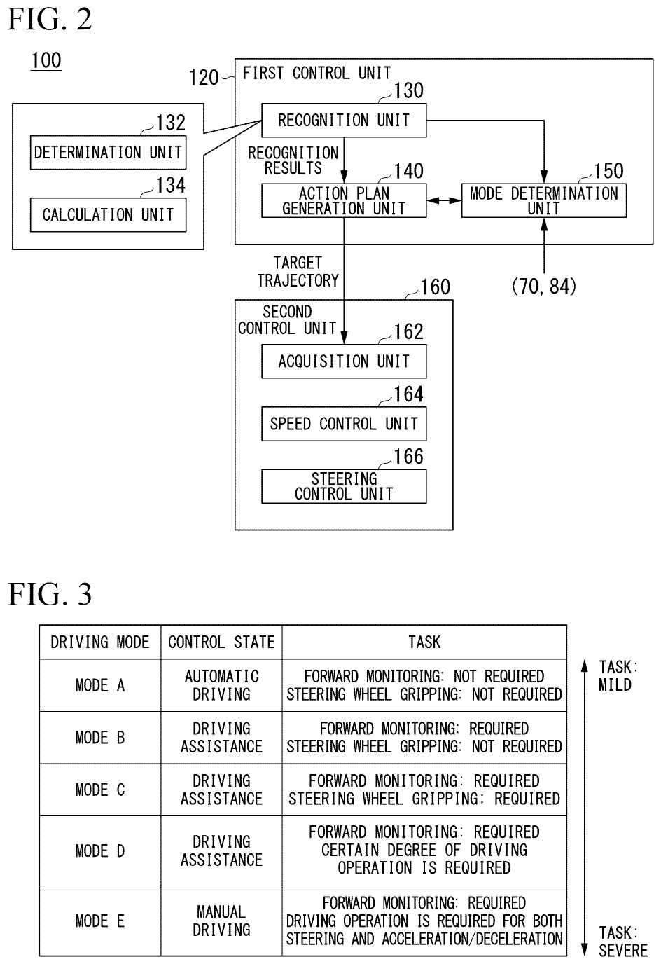

FIG. 2 is a functional configuration diagram of the first control unit 120 and the second control unit 160. The first control unit 120 includes, for example, a recognition unit 130, a determination unit 132, an action plan generation unit 140, and a mode determination unit 150. For example, the first control unit 120 realizes a function by artificial intelligence (AI) and a function by a model given in advance in parallel. For example, the function of “recognizing an intersection” may be realized by executing the recognition of an intersection by deep learning or the like and the recognition based on conditions given in advance (there are signals that can be pattern matched, road markings, and the like) in parallel, or may be realized by scoring and comprehensively evaluating both recognitions. As a result, the reliability of automatic driving is ensured.

The recognition unit 130 recognizes states such as the position, the speed, and the acceleration of an object near the own vehicle M on the basis of the information input from the camera 10, the radar device 12, and the LIDAR 14 via the object recognition device 16. The position of the object is recognized as, for example, a position on absolute coordinates with a representative point (the center of gravity, the center of a drive axis, or the like) of the own vehicle M set as the origin and is used for control. The position of the object may be represented by a representative point such as the center of gravity or a corner of the object, or may be represented by a region. The “state” of the object may include the acceleration, the jerk, or the “behavioral state” (for example, whether or not it is changing lanes or is about to change lanes) of the object.

In addition, the recognition unit 130 recognizes, for example, a lane (a traveling lane) in which the own vehicle Mis traveling. For example, the recognition unit 130 recognizes the traveling lane by comparing a pattern of a road dividing line obtained from the second map information 62 (hereinafter sometimes referred to as a “map road dividing line”) and a pattern of a road dividing line in the surroundings of the own vehicle M recognized from an image captured by the camera 10 (hereinafter sometimes referred to as a “camera road dividing line”) with each other. More specifically, the determination unit 132 of the recognition unit 130, for example, calculates the deviation between the map road dividing line and the camera road dividing line, and in a case in which it is determined that the calculated deviation is less than or equal to a predetermined value (that is, in a case in which it is determined that the map road dividing line and the camera road dividing line match each other), at least one of the map road dividing line and the camera road dividing line (or a midline thereof, or the like) is recognized as a traveling lane. Here, the deviation may be, for example, an angle between the map road dividing line and the camera road dividing line, or a distance between the map road dividing line and the camera road dividing line. In a case in which the distance between the map road dividing line and the camera road dividing line, for example, one or more representative points may be extracted from each of the map road dividing line and the camera road dividing line within a predetermined range in the traveling direction of the own vehicle M, and the distance between these representative points may be taken as the deviation. The recognition unit 130 may recognize the traveling lane by recognizing not only the road dividing line but also a traveling road boundary (a road boundary) including the road dividing line, a road shoulder, a curbstone, a median strip, a guardrail, and the like. In this recognition, the position of the own vehicle M acquired from the navigation device 50 and the processing results by the INS may be taken into account. In addition, the recognition unit 130 also recognizes a stop line, an obstacle, a red light, a tollgate, and other road events. The camera road dividing line is an example of a “recognized road dividing line” in the claims.

The recognition unit 130 recognizes the position and posture of the own vehicle M with respect to the traveling lane when recognizing the traveling lane. The recognition unit 130 may recognize, for example, a deviation of a reference point of the own vehicle M from the center of the lane and an angle formed between the traveling direction of the own vehicle M and a line along the center of the lane as a relative position and a posture of the own vehicle M with respect to the traveling lane. The recognition unit 130 may recognize the position of the reference point of the own vehicle M with respect to any side end portion (a road dividing line or a road boundary) of the traveling lane as the relative position of the own vehicle M with respect to the traveling lane, instead of these.

In principle, the action plan generation unit 140 generates a target trajectory along which the own vehicle M travels in the future automatically (regardless of the operation of the driver) such that the own vehicle M travels in the recommended lane determined by the recommended lane determination unit 61 and avoids approaching objects recognized by the recognition unit 130 (excluding objects that the own vehicle M can pass, such as road dividing lines, road markings, and manholes). For example, the recognition unit 130 sets a risk region centered on the object of which a state is output, and within the risk region, the recognition unit 130 sets a risk as an index value indicating the degree to which the own vehicle M should not approach. The action plan generation unit 140 generates a target trajectory such that the own vehicle M does not pass through any point where the risk is greater than or equal to a predetermined value and such that the own vehicle M travels within the recognized traveling lane. Since some objects are moving, the risk distribution is not one per control cycle, but is set for a plurality of future points in time, taking into account the future position of the object predicted on the basis of the speed of the object. For example, the target trajectory is expressed as an arrangement of points (trajectory points) to be reached by the own vehicle M in order. The trajectory point is a point to be reached by the own vehicle M for each predetermined traveling distance (for example, about several [m]) along the road. Separately from that, for a predetermined sampling time (for example, about 0 comma number [sec]), a target speed and a target acceleration are generated as a part of the target trajectory. In addition, the trajectory point may be a position to be reached by the own vehicle M at the sampling time for each predetermined sampling time. In this case, the information of the target speed and the target acceleration is expressed with an interval of the trajectory points.

Furthermore, in the present embodiment, in a case in which the determination unit 132 determines that the map road dividing line and the camera road dividing line match each other only on one side, the action plan generation unit 140 generates a target trajectory to cause the own vehicle M to travel along the matched map road dividing line and camera road dividing line (at least taking them into consideration). As an example, the action plan generation unit 140 generates a target trajectory to travel at a point shifted by a predetermined distance from the matched map road dividing line and camera road dividing line.

The action plan generation unit 140 may set events for the automatic driving when generating the target trajectory. The events for the automatic driving include a constant speed traveling event, a low speed following traveling event, a lane change event, a branching event, a merging event, a takeover event, and the like. The action plan generation unit 140 generates a target trajectory according to an activated event.

The mode determination unit 150 determines the driving mode of the own vehicle M to be one of a plurality of driving modes in which different tasks are imposed on the driver. FIG. 3 is a diagram showing an example of a correspondence relationship between a driving mode, a control state of the own vehicle M, and a task. The driving modes of the own vehicle M include, for example, five modes of mode A to mode E. The control state, that is, the degree of automation of the driving control of the own vehicle M, is highest in mode A, followed by mode B, mode C, and mode D in order, and lowest in mode E. Conversely, the task imposed on the driver is the mildest in mode A, followed by mode B, mode C, and mode D in order, with mode E being the most severe. Since modes D and E are in a non-automatic driving control state, the automatic driving control device 100 has a responsibility to end control related to the automatic driving and transition to the driving assistance or the manual driving. The contents of each driving mode will be exemplified below.

In mode A, the own vehicle is in an automatic driving state, and either of forward monitoring or gripping the steering wheel 82 (steering wheel gripping in the drawing) is not imposed on the driver. However, even in mode A, the driver is required to be in a posture in which the driver can quickly transition to the manual driving in response to a request from the system including the automatic driving control device 100 as a main component. The term “automatic driving” used here means that both steering and acceleration/deceleration are controlled independently of the operation of the driver. The term “forward portion” refers to a space in the traveling direction of the own vehicle M that is visible through the front windshield. Mode A is a driving mode that can be executed in a case in which conditions that the own vehicle M travels at a predetermined speed (for example, approximately 50 km/h) or less on a motorway such as an expressway and a preceding vehicle to be followed is present are satisfied, and is sometimes referred to as traffic jam pilot (TJP). In a case in which these conditions are no longer satisfied, the mode determination unit 150 changes the driving mode of the own vehicle M to mode B.

In mode B, the vehicle is in a driving assistance state, and the task to monitor the front of the own vehicle M (hereinafter referred to as “forward monitoring”) is imposed on the driver, but the task to grip the steering wheel 82 is not imposed on the driver. In mode C, the vehicle is in a driving assistance state, and the task of forward monitoring and the task to grip the steering wheel 82 are imposed on the driver. Mode D is a driving mode in which a certain degree of a driving operation by the driver is required for at least one of steering and acceleration/deceleration of the own vehicle M. For example, in mode D, driving assistance such as adaptive cruise control (ACC) and a lane keeping assist system (LKAS) is performed. In mode E, the vehicle is in a manual driving state in which the driving operation by the driver is required for both the steering and acceleration/deceleration. In both mode D and mode E, the task to monitor the forward portion of the own vehicle M is naturally imposed on the driver.

The driving modes are not limited to those illustrated in FIG. 3 and may be defined by other definitions. For example, among driving modes in which both the forward monitoring and the steering wheel gripping are required, there may be driving modes with a loose or strict threshold value for determining that the steering wheel is gripped. More specifically, driving modes may be defined such that in one driving mode, either of the left hand or the right hand of the driver only has to touch the steering wheel 82, while in another driving mode in which a task that is imposed on the driver is heavier than in the one driving mode, the driver has to grip the steering wheel 82 with both hands with a strength greater than or equal to a threshold value. Alternatively, driving modes having different severities of tasks imposed on the driver may be defined in any way.

The automatic driving control device 100 (and a driving assistance device (not shown)) executes an automatic lane change in accordance with the driving mode. The automatic lane change includes a system-requested automatic lane change (1) and a driver-requested automatic lane change (2). The automatic lane change (1) include an automatic lane change for overtaking, which is performed in a case in which the speed of the preceding vehicle is less than the speed of the own vehicle by a reference value or more, and an automatic lane change for proceeding toward a destination (an automatic lane change due to a change in the recommended lane). The automatic lane change (2) causes the own vehicle M to change lanes in an operation direction in a case in which conditions related to the speed, the positional relationship with surrounding vehicles the like are satisfied and in a case in which a turn signal is operated by the driver.

In mode A, the automatic driving control device 100 does not execute either of the automatic lane change (1) or the automatic lane change (2). In modes B and C, the automatic driving control device 100 executes both of the automatic lane changes (1) and (2). In mode D, the driving assistance device (not shown) does not execute the automatic lane change (1) but executes the automatic lane change (2). In mode E, either of the automatic lane change (1) or the automatic lane change (2) is not executed.

In a case in which a task related to the determined driving mode (hereinafter referred to as a current driving mode) is not executed by the driver, the mode determination unit 150 changes the driving mode of the own vehicle M to a driving mode with a more severe task.

For example, in mode A, in a case in which the driver is in a posture in which the driver cannot transition to the manual driving in response to a request from the system (for example, in a case in which the driver continues to look away from the vehicle outside the allowed area or in a case in which signs of difficulty in driving are detected), the mode determination unit 150 performs control to prompt the driver to transition to the manual driving using the HMI 30, and if the driver does not respond, to move the own vehicle M to the road shoulder and gradually stop it, thereby stopping the automatic driving. After the automatic driving is stopped, the own vehicle is in a state of mode D or E, and the own vehicle M can be started by the manual operation of the driver. The same applies below with respect to “stopping automatic driving.” In mode B, in a case in which the driver is not monitoring the forward portion, the mode determination unit 150 performs control to prompt the driver to monitor the forward portion using the HMI 30, and if the driver does not respond, to move the own vehicle M to the road shoulder and gradually stop it, thereby stopping the automatic driving. In mode C, in a case in which the driver is not monitoring the forward portion or is not gripping the steering wheel 82, the mode determination unit 150 performs control to prompt the driver to monitor the forward portion and/or to grip the steering wheel 82 using the HMI 30, and if the driver does not respond, to move the own vehicle M to the road shoulder and gradually stop it, thereby stopping the automatic driving.

The mode determination unit 150 further monitors the state of the driver for the above-mentioned mode change, and determines whether or not the state of the driver is appropriate for the task. For example, the mode determination unit 150 analyzes the image captured by the driver monitoring camera 70 and performs posture estimation processing to determine whether or not the driver is in a posture in which the driver cannot transition to the manual driving in response to a request from the system. In addition, a driver state determination unit 152 analyzes the image captured by the driver monitoring camera 70 and performs line-of-sight estimation processing to determine whether or not the driver is monitoring the forward portion.

In addition, in the present embodiment, in a case in which the judgment unit 132 determines that the map road dividing line and the camera road dividing line do not match each other on both sides, the mode determination unit 150 changes the driving mode of the own vehicle M to a driving mode with a more severe task. For example, in a case in which it is determined that the map road dividing line and the camera road dividing line do not match each other on both sides when the own vehicle M travels in a driving mode (mode A or mode B) in which gripping of the steering wheel is not required, the mode determination unit 150 changes the driving mode to mode C or lower.

In addition, in the present embodiment, in a case in which the determination unit 132 determines that the map road dividing line and the camera road dividing line match each other only on one side when the own vehicle M travels in a driving mode (mode A or mode B) in which gripping of the steering wheel is not required, the mode determination unit 150 continues the driving mode of mode A or mode B. In this case, as described above, the action plan generation unit 140 generates a target trajectory along the matched map road dividing line or camera road dividing line.

The mode determination unit 150 further performs various pieces of processing for changing the mode. For example, the mode determination unit 150 instructs the action plan generation unit 140 to generate a target trajectory for stopping on the road shoulder, instructs a driving assistance device (not shown) to operate, or controls the HMI 30 to prompt the driver to take action.

The second control unit 160 controls the traveling drive force output device 200, the brake device 210, and the steering device 220 such that the own vehicle M passes along the target trajectory generated by the action plan generation unit 140 at a scheduled time.

Returning to FIG. 2, the second control unit 160 includes, for example, an acquisition unit 162, a speed control unit 164, and a steering control unit 166. The acquisition unit 162 acquires the information on the target trajectory (the trajectory point) generated by the action plan generation unit 140 and stores it in a memory (not shown). The speed control unit 164 controls the traveling drive force output device 200 or the brake device 210 on the basis of the speed element associated with the target trajectory stored in the memory. The steering control unit 166 controls the steering device 220 according to a curving degree of the target trajectory stored in the memory. The processing of the speed control unit 164 and the steering control unit 166 is realized by, for example, a combination of feedforward control and feedback control. As an example, the steering control unit 166 executes a combination of feedforward control according to the curvature of the road in front of the own vehicle M and feedback control based on a deviation from the target trajectory.

The traveling drive force output device 200 outputs a traveling driving force (torque) for the vehicle to travel to the drive wheels. The traveling drive force output device 200 includes, for example, a combination of an internal combustion engine, an electric motor, a transmission, and the like and an electronic control unit (ECU) that controls them. The ECU controls the above configuration according to the information input from the second control unit 160 or the information input from the driving operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to the information input from the second control unit 160 or the information input from the driving operator 80 such that brake torque corresponding to a braking operation is output to each wheel. The brake device 210 may include a mechanism for transmitting the hydraulic pressure generated by the operation of the brake pedal included in the driving operator 80 to the cylinder via a master cylinder as a backup. The brake device 210 is not limited to the configuration described above and may be an electronically controlled hydraulic brake device that controls an actuator according to the information input from the second control unit 160 and transmits the hydraulic pressure of the master cylinder to the cylinder.

The steering device 220 includes, for example, a steering ECU and an electric motor. The electric motor applies a force to a rack and pinion mechanism to change the direction of a turning wheel, for example. The steering ECU drives the electric motor according to the information input from the second control unit 160 or the information input from the driving operator 80 and changes the direction of the turning wheel.

[Processing when One-Sided Match Occurs]

As described above, the determination unit 132 compares the map road dividing line and the camera road dividing line with each other on both sides, and in a case in which it is determined that the map road dividing line and the camera road dividing line match each other on at least one side, the action plan generation unit 140 generates a target trajectory to cause the own vehicle M to travel along the matched map road dividing line and camera road dividing line. However, for example, in a case in which the camera road dividing line and the map road dividing line do not match each other on one side, while the camera road dividing line and the map road dividing line match each other only on the other side, and then a deviation occurs between the camera road dividing line and the map road dividing line on the matched side, in the related art, the road dividing lines with a smaller change in lane width between the camera road dividing lines and the map road dividing lines may be erroneously selected for traveling control.

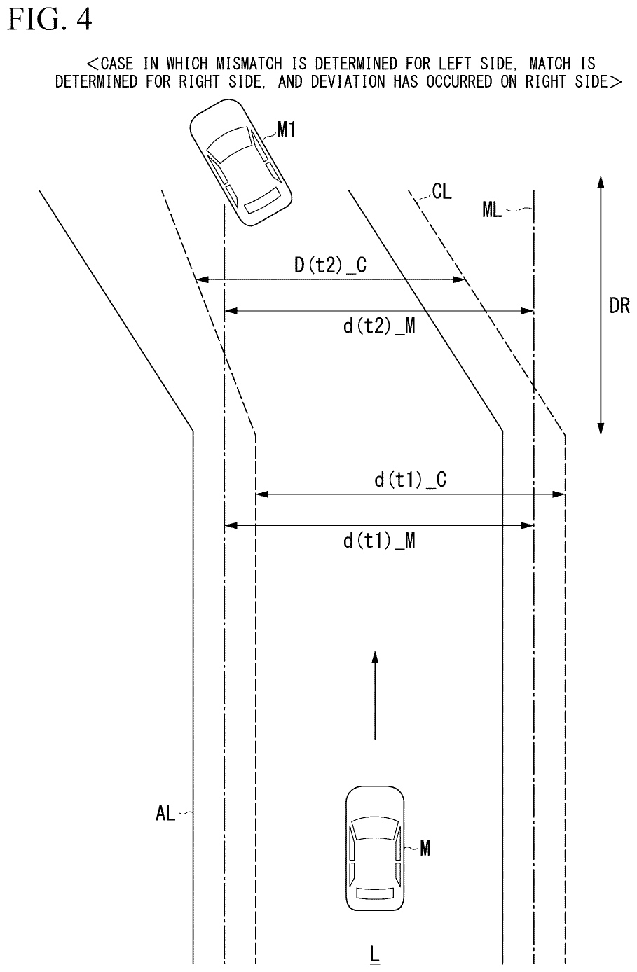

FIG. 4 is a diagram for explaining erroneous selection of a traveling road in the related art. In FIG. 4, the reference sign L represents the traveling lane in which the own vehicle M travels, the reference sign M1 represents a vehicle preceding the own vehicle M, the reference sign AL represents the actual road dividing line, the reference sign CL represents the camera road dividing line of the traveling lane L, and the reference sign ML represents the map road dividing line of the traveling lane L. FIG. 4 shows, as an example, a situation in which a mismatch between the camera road dividing line CL and the map road dividing line ML is determined for the left side, while a match between the camera road dividing line CL and the map road dividing line ML is determined for the right side. The camera road dividing line CL and the map road dividing line ML shown on the left side are determined to be a mismatch in the previous determination, for example, and this determination has been continued for a predetermined period of time, and the previous determination of the mismatch is also held in the current determination.

As shown in FIG. 4, even on the right side where the camera road dividing line CL and the map road dividing line ML are determined to match each other, a deviation occurs in a deviation region DR. Such a situation may occur, for example, in a case in which the actual road dividing line AL is redrawn from a straight road due to construction or the like, and the camera road dividing line CL properly captures the road dividing line AL, but the map road dividing line ML has not been updated. In such a case, in the related art, for example, a distance between both sides of each of the camera road dividing line CL and the map road dividing line ML is calculated as the lane width in time series, and the road dividing lines with a smaller change in lane width are used as the more reliable road dividing lines for the automatic driving or the driving assistance. For example, in the case of FIG. 4, a change amount ΔWcam=|d(t2)_C−d(t1)_C| between a lane width d(t1)_C of the camera road dividing lines ML at time t1 and a lane width d(t2)_C of the camera road dividing lines ML at time t2 is a positive value, while a change amount ΔWmap=|d(t2)_M−d(t1)_M| between a lane width d(t1)_M of the map road dividing lines ML at time t1 and a lane width d(t2)_M of the map road dividing lines ML at time t2 is zero. For this reason, in the related art, the map road dividing lines ML with a smaller change in lane width may be erroneously used as more reliable road dividing lines for the automatic driving or the driving assistance.

In light of the above circumstances, in the present embodiment, the action plan generation unit 140 combines road dividing line selection processing based on the change amount in lane width (basic processing) with road dividing line selection processing based on a movement trajectory of the preceding vehicle (the present invention processing 1), and then reconciles the results of these (the present invention processing 2), thereby ultimately determining the road dividing line to be used for the traveling control. In a case in which there is no preceding vehicle ahead of the own vehicle M, the action plan generation unit 140 executes only the basic processing which will described below and determines the road dividing line to be used for the traveling control.

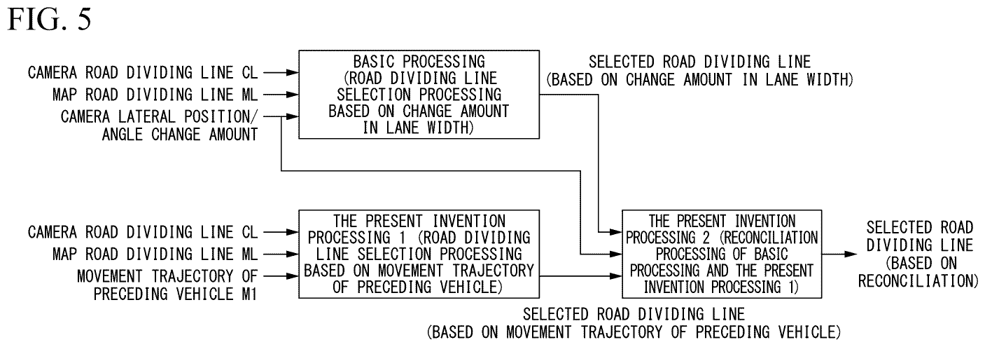

FIG. 5 is a diagram for explaining an overview of the basic processing, the present invention processing 1, and the present invention processing 2 according to the embodiment. As shown in FIG. 5, the processing according to the present embodiment includes: the basic processing of selecting either of the camera road dividing line CL or the map road dividing line ML in accordance with input of the camera road dividing line CL, the map road dividing line ML, and a camera lateral position/angle change amount, and outputting it as the selected road dividing line; the present invention processing 1 of selecting either of the camera road dividing line CL or the map road dividing line ML in accordance with input of the camera road dividing line CL, the map road dividing line ML, and the movement trajectory of the preceding vehicle M1, and outputting it as the selected road dividing line; and the present invention processing 2 of selecting either of the camera road dividing line CL or the map road dividing line ML in accordance with input of the selected road dividing line output by the basic processing, the selected road dividing line output by the present invention processing 1, and the camera lateral position/angle change amount, and outputting it as the selected road dividing line to be ultimately used for the traveling control. In the situation shown in FIG. 4 above, the map road dividing line ML is output by the basic processing, while in combination with the present invention processing 1 and the present invention processing 2, the camera road dividing line CL is ultimately determined as the road dividing line to be used for the traveling control, and thus it is possible to continue the traveling control of the vehicle with a high degree of accuracy by combining a plurality of traveling road determinations with each other. The basic processing, the present invention processing 1, and the present invention processing 2 will be described in detail below. The following processing is executed in a situation similar to that shown in FIG. 4, in which the determination unit 132 determines that the camera road dividing line CL and the map road dividing line ML match each other on only one side and that a deviation has occurred between the camera road dividing line CL and the map road dividing line ML on the one side.

### [Basic Processing]

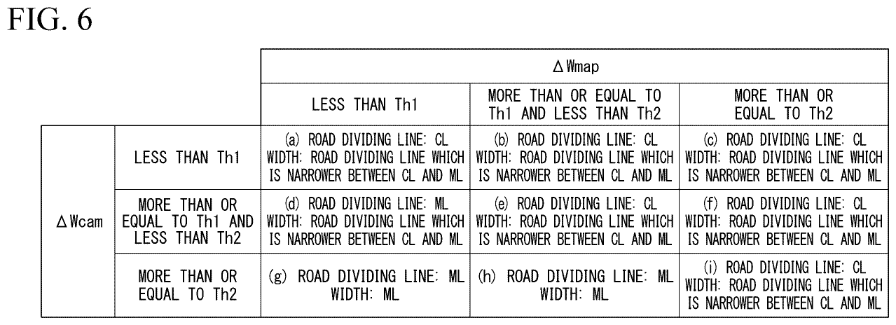

FIG. 6 is a diagram for explaining details of the basic processing according to the embodiment. A table shown in FIG. 6 specifies that, in principle, road dividing lines with a smaller change amount in lane width (ΔWcam or ΔWmap) are evaluated to be more reliable and the road dividing lines to be used for the traveling control are selected. When the change amount in lane width is approximately the same, the camera road dividing lines CL, which generally tend to be more reliable, are used preferentially.

First, as shown in patterns (a), (b), and (c) of FIG. 6, in a case in which the change amount in lane width ΔWcam of the camera road dividing lines is less than a first threshold value Th1, the action plan generation unit 140 adopts the camera road dividing line CL from the side where the camera road dividing line CL and the map road dividing line ML match each other. On the other hand, from the side where the camera road dividing line CL and the map road dividing line ML do not match each other, road dividing lines which are narrower between the camera road dividing lines CL and the map road dividing lines ML are adopted. The action plan generation unit 140 calculates the center line of the traveling road by offsetting a distance Wm/2, which is half a width Wm between the two adopted road dividing lines, from the camera road dividing line CL on the matched side.

Next, as shown in pattern (d) of FIG. 6, in a case in which the change amount in lane width ΔWcam of the camera road dividing lines is greater than or equal to the first threshold value Th1 and less than a second threshold value Th2 (Th2>Th1) and the change amount in lane width ΔWmap of the map road dividing lines ML is less than the first threshold Th1, the action plan generation unit 140 adopts the map road dividing line ML from the side where the camera road dividing line CL and the map road dividing line ML match each other. On the other hand, from the side where the camera road dividing line CL and the map road dividing line ML do not match each other, road dividing lines which are narrower between the camera road dividing lines CL and the map road dividing lines ML are adopted. The action plan generation unit 140 calculates the center line of the traveling road by offsetting a distance Wm/2, which is half a width Wm between the two adopted road dividing lines, from the map road dividing line ML on the matched side.

Next, as shown in patterns (e) and (f) of FIG. 6, in a case in which the change amount in lane width ΔWcam of the camera road dividing lines is greater than or equal to the first threshold value Th1 and less than a second threshold value Th2 and the change amount in lane width ΔWmap of the map road dividing lines ML is greater than or equal to the first threshold Th1, the action plan generation unit 140 adopts the camera road dividing line CL from the side where the camera road dividing line CL and the map road dividing line ML match each other. On the other hand, from the side where the camera road dividing line CL and the map road dividing line ML do not match each other, road dividing lines which are narrower between the camera road dividing lines CL and the map road dividing lines ML are adopted. The action plan generation unit 140 calculates the center line of the traveling road by offsetting a distance Wm/2, which is half a width Wm between the two adopted road dividing lines, from the camera road dividing line CL on the matched side.

Next, as shown in patterns (g) and (h) of FIG. 6, in a case in which the change amount in lane width ΔWcam of the camera road dividing lines is greater than or equal to the second threshold value Th2 and the change amount in lane width ΔWmap of the map road dividing lines ML is less than the second threshold value Th2, the action plan generation unit 140 adopts the map road dividing line ML from both sides of the side where the camera road dividing line CL and the map road dividing line ML match each other and the side where the camera road dividing line CL and the map road dividing line ML do not match each other. That is, the action plan generation unit 140 calculates the center line of the traveling road by offsetting a distance Wm/2, which is half a width Wm between the map road dividing lines on both sides, from the map road dividing line ML on the matched side.

Next, as shown in pattern (i) of FIG. 6, in a case in which each of the change amount in lane width ΔWcam of the camera road dividing lines and the change amount in lane width ΔWmap of the map road dividing lines ML is greater than or equal to the second threshold value Th2, the action plan generation unit 140 adopts the camera road dividing line CL from the side where the camera road dividing line CL and the map road dividing line ML match each other. On the other hand, from the side where the camera road dividing line CL and the map road dividing line ML do not match each other, road dividing lines which are narrower between the camera road dividing lines CL and the map road dividing lines ML are adopted. The action plan generation unit 140 calculates the center line of the traveling road by offsetting a distance Wm/2, which is half a width Wm between the two adopted road dividing lines, from the camera road dividing line CL on the matched side.

In this way, in the basic processing, the action plan generation unit 140 refers to the table shown in FIG. 6 in response to the input of the camera road dividing line CL and the map road dividing line ML, selects one of them, and outputs it as the selected road dividing line.

In the above processing, the action plan generation unit 140 determines whether or not each of the camera lateral position change amount and the angle change amount (that is, the lateral position change amount of the camera road dividing line CL and the angle change amount of the camera road dividing line CL) calculated by a calculation unit 134 is greater than or equal to a predetermined value, and in a case in which either the lateral position change amount or the angle change amount is greater than or equal to a predetermined value (that is, in a case in which the reliability of the camera road dividing line CL is low), may adopt the map road dividing line ML regardless of the change amount in lane width. Here, the camera lateral position change amount is a value obtained by subtracting an average value of the lateral coordinates of the points that constitute the past camera road dividing line CL over a predetermined number of past samples (for example, supplemented by the momentum of the own vehicle M or stored) from an average value of the lateral coordinates of the points that constitute the camera road dividing line CL in a predetermined range in front of the own vehicle M. Similarly, the camera angle change amount is a value obtained by subtracting an average value of the angles from the own vehicle M at the points that constitute the past camera road dividing line CL over a predetermined number of past samples (for example, supplemented by the momentum of the own vehicle M or stored) from an average value of the angles from the own vehicle M at the points that constitute the camera road dividing line CL in a predetermined range in front of the own vehicle M.

### [The Present Invention Processing 1]

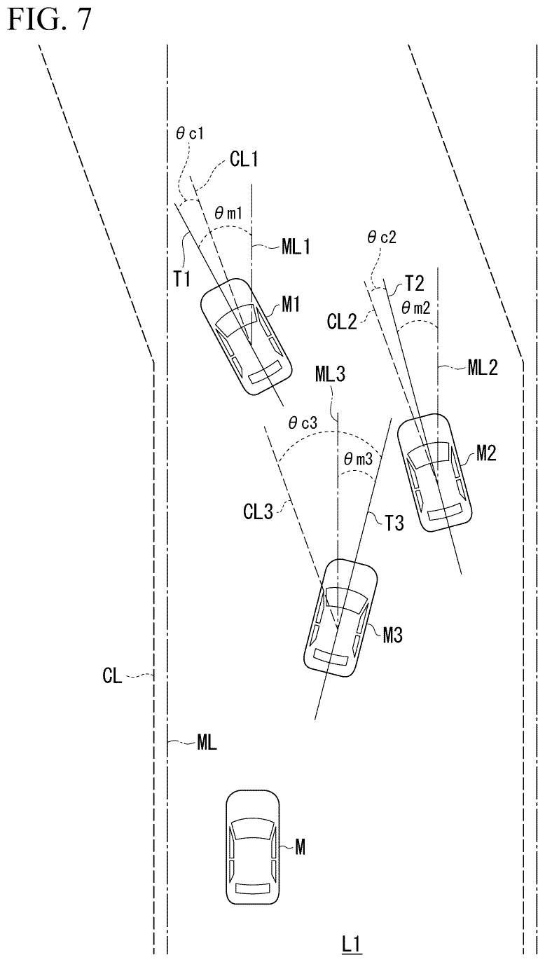

FIG. 7 is a diagram for explaining details of the present invention processing 1 according to the embodiment. The present invention processing 1 is processing for determining whether or not either of the camera road dividing line CL or the map road dividing line ML is along the movement trajectory of the preceding vehicle. In FIG. 7, the own vehicle M is traveling on a lane L1, and three other vehicles M1, M2, and M3 are traveling ahead of the own vehicle M.

In a case in which the determination unit 132 determines that there is a deviation between the camera road dividing line CL and the map road dividing line ML, the calculation unit 134 determines whether or not there are other vehicles greater than or equal to a third threshold value within a predetermined distance from the own vehicle M. In a case in which it is determined that there are other vehicles greater than or equal to a third threshold value within a predetermined distance from the own vehicle M, the calculation unit 134 calculates a parallelism between the trajectories of these other vehicles and the camera road dividing line CL using a method which will be described below.

For example, in the case of FIG. 7, the calculation unit 134 first calculates traveling trajectories T1, T2, and T3 for the other vehicles M1, M2, and M3, respectively. The calculation unit 134 can calculate the traveling trajectories T1, T2, and T3 by measuring the change in position of the other vehicles M1, M2, and M3 over a predetermined period of time on the basis of, for example, the camera images.

Next, the calculation unit 134 calculates deviation angles between the calculated traveling trajectories T1, T2, and T3, the camera road dividing lines CL, and the map road dividing lines ML. For example, in the case of FIG. 7, for the other vehicle M1, the calculation unit 134 calculates a deviation angle θc1 between the traveling trajectory T1 and a camera road dividing line CL1 (the camera road dividing line CL1 is illustrated by translating the camera road dividing line CL for the convenience of explaining a calculation method. The same applies to CL2 and CL3 below), and a deviation angle θm1 between the traveling trajectory T1 and a map road dividing line ML1 (the map road dividing line ML1 is illustrated by translating the map road dividing line ML for the convenience of explaining the calculation method. The same applies to ML2 and ML3 below). Similarly, for the other vehicle M2, the calculation unit 134 calculates a deviation angle θc2 between the traveling trajectory T2 and a camera road dividing line CL2, and a deviation angle θm2 between the traveling trajectory T2 and a map road dividing line ML2. Similarly, for the other vehicle M3, the calculation unit 134 calculates a deviation angle θc3 between the traveling trajectory T3 and a camera road dividing line CL3, and a deviation angle θm2 between the traveling trajectory T3 and a map road dividing line ML3. At this time, the calculation unit 134 calculates, for example, an angle in a clockwise direction on the basis of the traveling trajectory of the other vehicle as a positive deviation angle and an angle in a counterclockwise direction on the basis of the traveling trajectory of the other vehicle as a negative deviation angle (this setting may be reversed).

Next, for the detected other vehicles, the calculation unit 134 calculates an average value of the deviation angles between the calculated traveling trajectory T1 and the camera road dividing line CL1, and an average value of the deviation angles between the traveling trajectory T1 and the map road dividing line ML1. More specifically, in the case of FIG. 7, the calculation unit 134 calculates the average value of the deviation angles between the traveling trajectory T1 and the camera road dividing line CL1 using θc_av=(|θc1|+|θc2|+|θc3|)/3, and calculates the average value of the deviation angles between the traveling trajectory T1 and the map road dividing line ML1 using θm_av=(|θm1|+|θm2|+|θm3|)/3.

Next, the calculation unit 134 calculates a parallelism between the traveling trajectory T of the detected other vehicle and the camera road dividing line CL (the map road dividing line ML) using θm_av−θc_av (θc_av−θm_av). In other words, the parallelism θm_av−θc_av (θc_av−θm_av) can be said to be an index value that indicates whether the other vehicle is traveling more parallel to either of the camera road dividing line CL or the map road dividing line ML. It is indicated that the larger the value of the parallelism θm_av−θc_av (θc_av−θm_av), the more the other vehicle is traveling parallel to the camera road dividing line CL (the map road dividing line ML), and the smaller the value of the parallelism θm_av−θc_av (θc_av−θm_av), the more the other vehicle is traveling parallel to the map road dividing line ML (the camera road dividing line CL).

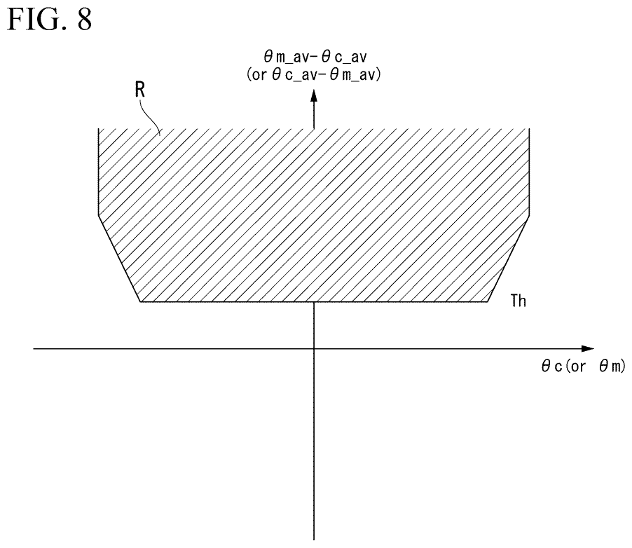

FIG. 8 is a graph for explaining a method for determining a road dividing line to be output in the present invention processing 1. As shown in FIG. 8, in a case in which the calculated parallelism θm_av−θc_av (θc_av−θm_av) is greater than or equal to a fourth threshold value (an region indicated by a diagonal line R), the action plan generation unit 140 determines that the reliability of the camera road dividing line CL (the map road dividing line ML) is higher than the reliability of the map road dividing line ML (the camera road dividing line CL), and outputs the camera road dividing line CL (the map road dividing line ML) as the selected road dividing line. The fourth threshold value here is set to a value greater than zero in consideration of a safety margin.

In a case in which the action plan generation unit 140 determines that both the calculated parallelism θm_av−θc_av and the calculated parallelism θc_av−θm_av are greater than or equal to the fourth threshold value, this means that both the camera road dividing line CL and the map road dividing line ML are along the movement trajectory of another vehicle and it is not possible to determine which is more reliable. For this reason, the action plan generation unit 140 ends the present invention processing 1 (and the subsequent present invention processing 2), and selects the road dividing lines with a smaller change in lane width only on the basis of the basic processing. Similarly, in a case in which the action plan generation unit 140 determines that both the calculated parallelism θm_av−θc_av and the calculated parallelism θc_av−θm_av are less than the fourth threshold value, this means that both the camera road dividing line CL and the map road dividing line ML are not along the movement trajectory of another vehicle and the reliability of both is low. For this reason, the action plan generation unit 140 ends the present invention processing 1 (and the subsequent present invention processing 2), and selects the road dividing lines with a smaller change in lane width only on the basis of the basic processing. On the other hand, in a case in which it is determined that only one of the parallelism θm_av−θc_av and the parallelism θc_av−θm_av is greater than or equal to the fourth threshold value, the action plan generation unit 140 outputs the road dividing line corresponding to the one as the selected road dividing line. For example, in a case in which θm_av−θc_av is greater than or equal to the fourth threshold value, the action plan generation unit 140 outputs the camera road dividing line CL as the selected road dividing line, whereas in a case in which θc_av−θm_av is greater than or equal to the fourth threshold value, the action plan generation unit 140 outputs the map road dividing line ML as the selected road dividing line. As a result, it is possible to select the road dividing line that is more along the movement trajectory of the preceding vehicle between the camera road dividing line CL and the map road dividing line ML.

The action plan generation unit 140 may determine whether or not the deviation angle is less than or equal to a fifth threshold value for the majority of the other vehicles that are the subjects of the calculation of the deviation average value, in addition to the above conditions. Only in a case in which it is determined that only one of the parallelism θm_av−θc_av and the parallelism θc_av−θm_av is less than or equal to the fourth threshold value and the deviation angle is less than or equal to the fifth threshold value for the majority of the other vehicles that are the subjects of the calculation of the deviation average value, the action plan generation unit 140 may output one of the parallelism θm_av−θc_av and the parallelism θc_av−θm_av as the selected road dividing line. As a result, it is possible to further accurately select the road dividing line that is more along the movement trajectory of the preceding vehicle between the camera road dividing line CL and the map road dividing line ML.

Furthermore, in the present invention processing 1, the action plan generation unit 140 may determine whether or not an additional condition is satisfied. Only in a case in which the additional condition is satisfied in addition to the above conditions, the action plan generation unit 140 may output the selected road dividing line. On the other hand, in a case in which the additional condition is not satisfied, the action plan generation unit 140 may end the present invention processing 1 (and the subsequent present invention processing 2) and select the road dividing lines with a smaller change in lane width only on the basis of the basic processing. For example, the additional condition may include a condition that the determination unit 132 determines that the camera road dividing line CL and the map road dividing line ML match each other on only one side and that a deviation has occurred between the camera road dividing line CL and the map road dividing line ML on the one side. In addition, for example, the additional condition may include a condition that the other vehicle that is the subject of the processing of the present invention processing 1 is located a predetermined distance or more away from the own vehicle M. In addition, for example, the additional condition may include a condition that within a predetermined range ahead of the own vehicle M, the deviation between the camera road dividing line CL and the map road dividing line ML on the matched one side is a predetermined angle or more.

The additional condition may further be a condition for excluding situations in which the accuracy of the present invention processing 1 and the present invention processing 2 is expected to decrease. For example, the additional condition may include a condition that the own vehicle Mis not changing lanes. The action plan generation unit 140 can determine, for example, whether or not the own vehicle M is changing lanes on the basis of whether or not the own vehicle M is crossing the camera road dividing line CL or the map road dividing line ML while operating the turn signal. In addition, for example, the additional condition may include a condition that an index value indicating the degree of curvature of the traveling lane in which the own vehicle Mis traveling is less than or equal to a predetermined value. For example, the action plan generation unit 140 can calculate the curvature of the camera road dividing line CL or the map road dividing line ML as the index value indicating the degree of curvature of the traveling lane, and determine whether the calculated curvature is less than or equal to a predetermined value. In addition, for example, the additional condition may include a condition that the own vehicle M is not traveling near a branch road. For example, the action plan generation unit 140 can refer to the second map information 62 and compare the second map information 62 with the current position of the own vehicle M to determine whether or not the own vehicle M is traveling near the branch road.

### [the Present Invention Processing 2]

The present invention processing 2 is processing for reconciling the road dividing line output by the basic processing with the road dividing line output by the present invention processing 1, and ultimately determining the dividing line to be used for the traveling control. In a case in which there is a preceding vehicle around the own vehicle M, the present invention processing 2 prioritizes the output result of the present invention processing 1 (interrupts the output result of the basic processing), and in a case in which the reliability of the output result of the present invention processing 1 is low, the present invention processing 2 adopts the output result of the basic processing as it is. The present invention processing 2 will be described in detail below.

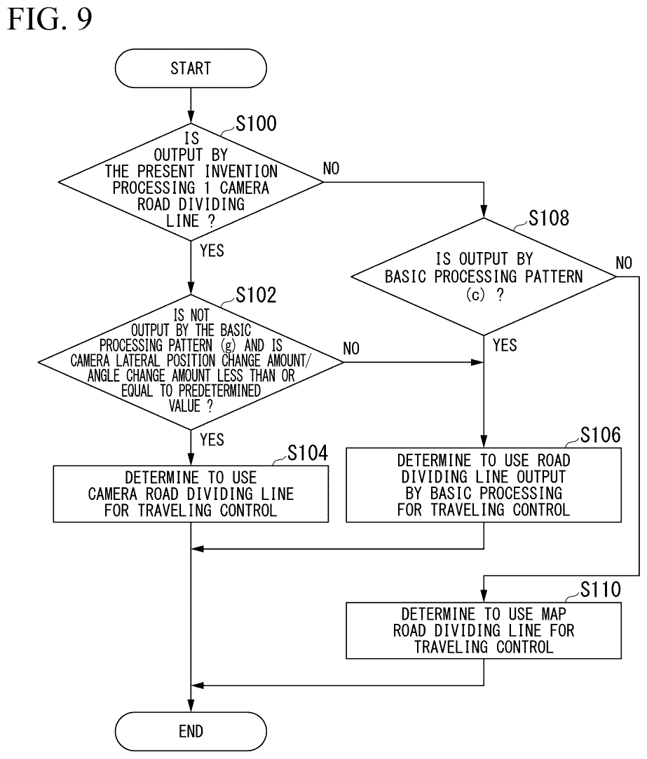

FIG. 9 is a flowchart showing an example of the flow of the present invention processing 2 according to the embodiment. For example, the processing of the flowchart shown in FIG. 9 is performed at the timing when the camera road dividing line and the map road dividing line do not match each other on one side, while the camera road dividing line and the map road dividing line match each other only on the other side, and then a deviation occurs between the camera road dividing line and the map road dividing line on the matched side, the above-mentioned basic processing and the present invention processing 1 are executed, and the results of the basic processing and the present invention processing 1 are obtained. As described above, in the present invention processing 1, in a case in which it is determined that the other vehicle is along both the camera road dividing line and the map road dividing line or the other vehicle is not along either of the camera road dividing line or the map road dividing line, the road dividing lines with a smaller change in lane width between the camera road dividing lines and the map road dividing lines are selected only on the basis of the basic processing.

First, the action plan generation unit 140 determines whether the road dividing line output by the present invention processing 1 is the camera road dividing line CL or the map road dividing line ML (step S100). In a case in which it is determined that the road dividing line output by the present invention processing 1 is the camera road dividing line CL, the action plan generation unit 140 determines whether or not the output by the basic processing is not the pattern (g), that is, the change amount in the lane width of the camera road dividing lines CL is not significantly large and whether or not each of the camera lateral position change amount and the angle change amount is less than or equal to a predetermined value (step S102). This step verifies the reliability of the camera road dividing line CL before determining to interrupt by the present invention processing 1. In a case in which it is determined that the output by the basic processing is not the pattern (g) and each of the camera lateral position change amount and the angle change amount is less than or equal to a predetermined value, this means that the reliability of the camera road dividing line CL is high, and thus the action plan generation unit 140 determines to use the camera road dividing line CL for the traveling control (step S104).

On the other hand, in a case in which it is determined that the output by the basic processing is the pattern (g) or each of the camera lateral position change amount and the angle change amount is greater than a predetermined value, this means that the reliability of the camera road dividing line CL is low, and thus the action plan generation unit 140 determines to use the road dividing line output by the basic processing, that is, in this case, the map road dividing line ML, for the traveling control (step S106). In step S100, in a case in which it is determined that the road dividing line output by the present invention processing 1 is the map road dividing line ML, the action plan generation unit 140 determines whether or not the output by the basic processing is pattern (c), that is, the change amount in the lane width of the map road dividing lines ML is not significantly large (step S108).

In a case in which it is determined that the output by the basic processing is the pattern (c), this means that the reliability of the map road dividing line ML is low, and thus the action plan generation unit 140 determines to use the road dividing line output by the basic processing, that is, in this case, the camera road dividing line CL, for the traveling control (step S106). On the other hand, in a case in which it is determined that the output by the basic processing is not the pattern (c), this means that the reliability of the map road dividing line ML is high, and thus the action plan generation unit 140 determines to use the map road dividing line ML for the traveling control (step S110). As a result, the processing in the present flowchart ends.

### [Traveling Control]

When the action plan generation unit 140 determines the driving line to be ultimately used for the traveling control between the camera road dividing line CL and the map road dividing line ML, the action plan generation unit 140 holds the dividing line for a predetermined period of time and generates a target trajectory along the dividing line. At this time, the mode determination unit 150 may continue the driving mode of the own vehicle M as it is, or may change the driving mode to a driving mode with a more severe task after continuing the driving mode for a certain period of time. In the situation shown in FIG. 4, the action plan generation unit 140 uses the camera road dividing line CL output by the present invention processing 1 for the traveling control by interrupting the map road dividing line ML output by the basic processing. Therefore, even in a situation in which the map road dividing line ML has not been updated to the latest information, the action plan generation unit 140 can appropriately generate a target trajectory, and the mode determination unit 150 can continue the current driving mode for at least a certain period of time.

According to the present embodiment described above, in a case in which it is determined that there is a deviation between the camera road dividing line and the map road dividing line, when the other vehicle is recognized, the traveling control is performed on the basis of the road dividing line that is closer to the movement trajectory of the other vehicle between the camera road dividing line and the map road dividing line, whereas when no other vehicle is recognized, the traveling control is performed on the basis of the road dividing lines with a smaller change in lane width between the camera road dividing lines and the map road dividing lines. As a result, it is possible to continue the traveling control of the vehicle with a high degree of accuracy by combining a plurality of traveling road determinations with each other.

The embodiment described above can be expressed as follows.

A vehicle control device including:
a storage medium storing computer-readable instructions; and
a processor connected to the storage medium,
the processor executing the computer-readable instructions to:
recognize a road dividing line and the other vehicle present in a traveling direction of a vehicle;
determine whether or not the recognized road dividing line matches a map road dividing line based on map information stored in a storage unit, and determine a deviation between the recognized road dividing line and the map road dividing line that match each other;
calculate a distance between road dividing lines on both sides of each of the recognized road dividing line and the map road dividing line as a lane width; and
perform traveling control of the vehicle on the basis of at least one of the recognized road dividing line and the map road dividing line,
wherein, in a case in which it is determined that there is a deviation between the recognized road dividing line and the map road dividing line, when the other vehicle is recognized, the traveling control is performed on the basis of the road dividing line that is closer to a movement trajectory of the other vehicle between the recognized road dividing line and the map road dividing line, whereas when no other vehicle is recognized, the traveling control is performed on the basis of the road dividing lines with a smaller change in the lane width between the recognized road dividing lines and the map road dividing lines.

Although forms for carrying out the present invention have been described above using the embodiments, the present invention is not limited to these embodiments, and various modifications and substitutions can be made without departing from the gist of the present invention.

What is claimed is:

1. A vehicle control device comprising:
a storage medium storing computer-readable instructions; and
a processor connected to the storage medium,
the processor executing the computer-readable instructions to:
recognize a road dividing line and another vehicle present in a traveling direction of a vehicle;
determine whether or not the recognized road dividing line matches a map road dividing line based on map information stored in a storage unit, and determine a deviation between the recognized road dividing line and the map road dividing line that match each other;
calculate a distance between road dividing lines on both sides of each of the recognized road dividing line and the map road dividing line as a lane width; and
perform traveling control of the vehicle on the basis of at least one of the recognized road dividing line and the map road dividing line,
wherein, in a case in which it is determined that there is a deviation between the recognized road dividing line and the map road dividing line, when the other vehicle is recognized, the processor performs the traveling control on the basis of the road dividing line that is closer to a movement trajectory of the other vehicle between the recognized road dividing line and the map road dividing line, whereas when no other vehicle is recognized, the processor performs the traveling control on the basis of the road dividing lines with a smaller change in the lane width between the recognized road dividing lines and the map road dividing lines.

2. The vehicle control device according to claim 1, wherein, in a case in which the change in the lane width of the recognized road dividing lines is greater than or equal to a threshold value, the processor performs the traveling control on the basis of the map road dividing line, whereas in a case in which the change in the lane width of the map road dividing lines is greater than or equal to the threshold value, the processor performs the traveling control on the basis of the recognized road dividing line.

3. The vehicle control device according to claim 1, wherein, in a case in which it is determined that both the recognized road dividing line and the map road dividing line are along the movement trajectory of the other vehicle, the processor performs the traveling control on the basis of the road dividing line that is closer to the movement trajectory of the other vehicle between the recognized road dividing line and the map road dividing line.

4. The vehicle control device according to claim 1, wherein, in a case in which it is determined that the recognized road dividing line and the map road dividing line match each other on only one side and that a deviation has occurred on the one side, when the other vehicle is recognized, the processor performs the traveling control on the basis of the road dividing line that is closer to the movement trajectory of the other vehicle between the recognized road dividing line and the map road dividing line, whereas when no other vehicle is recognized, the processor performs the traveling control on the basis of the road dividing lines with a smaller change in the lane width between the recognized road dividing lines and the map road dividing lines.

5. The vehicle control device according to claim 1, wherein, in a case in which the vehicle is not changing lanes and it is determined that there is a deviation between the recognized road dividing line and the map road dividing line, when the other vehicle is recognized, the processor performs the traveling control on the basis of the road dividing line that is closer to the movement trajectory of the other vehicle between the recognized road dividing line and the map road dividing line, whereas when no other vehicle is recognized, the processor performs the traveling control on the basis of the road dividing lines with a smaller change in the lane width between the recognized road dividing lines and the map road dividing lines.

6. The vehicle control device according to claim 1, wherein, in a case in which an index value indicating a degree of curvature of a traveling lane of the vehicle is less than or equal to a predetermined value and it is determined that there is a deviation between the recognized road dividing line and the map road dividing line, when the other vehicle is recognized by the control unit, the processor performs the traveling control on the basis of the road dividing line that is closer to the movement trajectory of the other vehicle between the recognized road dividing line and the map road dividing line, whereas when no other vehicle is recognized by the recognition unit, the processor performs the traveling control on the basis of the road dividing lines with a smaller change in the lane width between the recognized road dividing lines and the map road dividing lines.

7. The vehicle control device according to claim 1, wherein, in a case in which the vehicle is not traveling near a branch road and it is determined that there is a deviation between the recognized road dividing line and the map road dividing line, when the other vehicle is recognized, the processor performs the traveling control on the basis of the road dividing line that is closer to the movement trajectory of the other vehicle between the recognized road dividing line and the map road dividing line, whereas when no other vehicle is recognized, the processor performs the traveling control on the basis of the road dividing lines with a smaller change in the lane width between the recognized road dividing lines and the map road dividing lines.

8. A vehicle control method causing a computer installed in a vehicle to:
recognize a road dividing line and the other vehicle present in a traveling direction of a vehicle;
determine whether or not the recognized road dividing line matches a map road dividing line based on map information stored in a storage unit, and determine a deviation between the recognized road dividing line and the map road dividing line that match each other;
calculate a distance between road dividing lines on both sides of each of the recognized road dividing line and the map road dividing line as a lane width; and
perform traveling control of the vehicle on the basis of at least one of the recognized road dividing line and the map road dividing line,
wherein, in a case in which it is determined that there is a deviation between the recognized road dividing line and the map road dividing line, when the other vehicle is recognized, the traveling control is performed on the basis of the road dividing line that is closer to a movement trajectory of the other vehicle between the recognized road dividing line and the map road dividing line, whereas when no other vehicle is recognized, the traveling control is performed on the basis of the road dividing lines with a smaller change in the lane width between the recognized road dividing lines and the map road dividing lines.

9. A computer-readable non-transitory storage medium that stores a program causing a computer installed in a vehicle to:
recognize a road dividing line and the other vehicle present in a traveling direction of a vehicle;
determine whether or not the recognized road dividing line matches a map road dividing line based on map information stored in a storage unit, and determine a deviation between the recognized road dividing line and the map road dividing line that match each other;
calculate a distance between road dividing lines on both sides of each of the recognized road dividing line and the map road dividing line as a lane width; and
perform traveling control of the vehicle on the basis of at least one of the recognized road dividing line and the map road dividing line,
wherein, in a case in which it is determined that there is a deviation between the recognized road dividing line and the map road dividing line, when the other vehicle is recognized, the traveling control is performed on the basis of the road dividing line that is closer to a movement trajectory of the other vehicle between the recognized road dividing line and the map road dividing line, whereas when no other vehicle is recognized, the traveling control is performed on the basis of the road dividing lines with a smaller change in the lane width between the recognized road dividing lines and the map road dividing lines.
